(19) United States
(12) Patent Application Publication
(10) Pub. No.: US 2016/0097971 A1
(43) Pub. Date: Apr. 7, 2016

(54) IMAGE PROJECTION APPARATUS, IMAGE PROJECTION SYSTEM, IMAGE PROJECTION METHOD, AND DISPLAY APPARATUS

(71) Applicant: SONY CORPORATION, TOKYO (JP)

(72) Inventors: RYOKO HORIKOSHI, KANAGAWA (JP); NORIHIRO MATSUYAMA, KANAGAWA (JP)

(21) Appl. No.: 14/890,691

(22) PCT Filed: Jun. 18, 2014
(86) PCT No.: PCT/JP2014/066167

§ 371 Date: Nov. 12, 2015

(30) Foreign Application Priority Data
Jun. 26, 2013 (JP) 2013-133582

(51) Int. Cl. G03B 35/26; G03B 35/20

(52) U.S. Cl. CPC G03B 35/26; G03B 35/20

(57) ABSTRACT

[Object] To be able to provide an audience with an image having more presence, and also to provide a variety of image expressions.

[Solution] Provided is an image projection apparatus including: a first display unit to display a first image as a three-dimensional image utilizing a difference in a polarization direction of emission light; and a projection plate which is formed by an optically isotropic material in a predetermined thickness and onto which the first image is projected by the first display unit. The projection plate is disposed in a manner that a projection surface of the first image is inclined at a predetermined angle with respect to an emission surface of the first image in the first display unit, and also transmits at least a part of light from a surface on an opposite side of the projection surface.

### TECHNICAL FIELD

The present disclosure relates to an image projection apparatus, an image projection system, an image projection method, and a display apparatus.

### BACKGROUND ART

In various kinds of event, attraction, and the like, there is known a technique called pepper's ghost which presents an image to an audience by superimposing a real image and an image projected from a projector onto a screen or the like. By using the pepper's ghost technique, it is possible to provide an audience with an illusion as if an image is floating in a space, and to realize a variety of staging and expressions. For example, Patent Literature 1 proposes a technique in which an at least partially transparent foil screen fixed to a frame is disposed so as to have a predetermined angle with respect to the projection direction of the light from a projector, and the projection light from the projector is projected onto a surface of the foil screen to display a projection image from the projector into a space.

### CITATION LIST

### Patent Literature

Patent Literature 1: JP 2007-531034T

### SUMMARY OF INVENTION

### Technical Problem

Meanwhile, recently, the use of a three-dimensional image (3D image) as a projection image is demanded more strongly for providing an audience with an image experience having more presence and providing a variety of image expressions in the image projection into the space as above. Further, in a situation such as an event or an attraction in which it is supposed that a large number of people view the projection image from any directions, as a 3D image generation method, it is preferable to use a polarization method in which 3D image view depends comparatively little on the position of a viewer with respect to the screen and 3D image glasses to be worn by the viewer can be provided comparatively inexpensively.

In the technique described in Patent Literature 1, however, there is a possibility that the polarization direction of light forming the projection image is disturbed by the reflection at the foil screen when an image is projected onto the foil screen from the projector. In this manner, with the technique described in Patent Literature 1, it is difficult to control the polarization of the projection image, and there is a fear that the 3D image might not be generated well.

Accordingly, the present disclosure proposes a novel and also improved image projection apparatus, image projection system, image projection method, and display apparatus, which can provide an audience with an image having more presence and also provide a variety of image expressions.

### Solution to Problem

According to the present disclosure, there is provided an image projection apparatus including: a first display unit to display a first image as a three-dimensional image utilizing a difference in a polarization direction of emission light; and a projection plate which is formed by an optically isotropic material in a predetermined thickness and onto which the first image is projected by the first display unit. The projection plate is disposed in a manner that a projection surface of the first image is inclined at a predetermined angle with respect to an emission surface of the first image in the first display unit, and also transmits at least a part of light from a surface on an opposite side of the projection surface.

According to the present disclosure, there is provided an image projection system including: a first display apparatus to display a first image as a three-dimensional image utilizing a difference in a polarization direction of emission light; and a projection plate which is formed by an optically isotropic material in a predetermined thickness and onto which the first image is projected by the first display apparatus. The projection plate is disposed in a manner that a projection surface of the first image is inclined at a predetermined angle with respect to an emission surface of the first image in the first display apparatus, and also transmits at least a part of light from a surface on an opposite side of the projection surface.

There is provided an image projection method including: projecting a first image of a three-dimensional image onto a projection plate formed by an optically isotropic material in a predetermined thickness from a first display apparatus to display the first image utilizing a difference in a polarization direction of emission light. The projection plate is disposed in a manner that a projection surface of the first image is inclined at a predetermined angle with respect to an emission surface of the first image in the first display apparatus, and also transmits at least a part of light from a surface on an opposite side of the projection surface.

There is provided a display apparatus which displays a first image of a three-dimensional image by emitting light having a different polarization direction from an emission surface, and projects the first image toward a projection surface of a projection plate that has the projection surface disposed to be inclined at a predetermined angle with respect to the emission surface, that is formed by an optically isotropic material in a predetermined thickness, and that transmits at least a part of light from a surface on an opposite side of the projection surface.

According to the present disclosure, the first display unit that displays the first image as a three-dimensional image by the polarization method and the projection plate which is formed by an optically isotropic material in a predetermined thickness and onto which the first image is projected by the first display unit are provided. Further, the projection plate is disposed such that a projection surface onto which the first image is projected is inclined at a predetermined angle with respect to an emission surface of the first image in the first display unit, and also transmits at least a part of light from a surface on an opposite side of the projection surface. Accordingly, the first image of the three-dimensional image projected onto the projection plate is reflected at a predetermined angle while keeping the polarization direction of the light forming the first image, and provided for an audience observing the projection plate in the reflection direction thereof as the first projection image of the three-dimensional image. Further, a real image disposed in the direction of the surface on the opposite side of the projection surface of the first image is provided for the audience observing the projection plate as the transmission image transmitted through the projection plate. Accordingly, an image in which the first projection image of the three-dimensional image and the real image existing on the other side of the projection plate are superimposed is provided for the audience observing the projection plate.

### Advantageous Effects of Invention

According to the present disclosure, as explained above, it is possible to provide an audience with an image having more presence, and also to provide a variety of image expressions.

### BRIEF DESCRIPTION OF DRAWINGS

FIG. 1 is a perspective view showing a configuration example of an image projection apparatus according to a first embodiment of the present disclosure.

FIG. 2 is a side view showing a state when the image projection apparatus shown in FIG. 1 is viewed from the side.

FIG. 3A is an explanatory diagram for explaining an application example of an image projection apparatus according to the first embodiment.

FIG. 3B is an explanatory diagram for explaining an application example of an image projection apparatus according to the first embodiment.

FIG. 3C is an explanatory diagram for explaining an application example of an image projection apparatus according to the first embodiment.

FIG. 4 is an explanatory diagram for explaining a method of determining a thickness of a projection plate according to the first embodiment.

FIG. 5 is an explanatory diagram for explaining a reflectance of a first image at a projection plate.

FIG. 6 is a side view showing a configuration example of an image projection apparatus according to a second embodiment of the present disclosure.

FIG. 7A is an explanatory diagram for explaining an application example of the projection apparatus according to the second embodiment.

FIG. 7B is an explanatory diagram for explaining an application example of the projection apparatus according to the second embodiment.

### DESCRIPTION OF EMBODIMENTS

Hereinafter, (a) preferred embodiment(s) of the present disclosure will be described in detail with reference to the appended drawings. In this specification and the drawings, elements that have substantially the same function and structure are denoted with the same reference signs, and repeated explanation is omitted.

Here, the explanation will be given in the following order.

1. First embodiment
1-1. Configuration of an image projection apparatus
1-2. Application example
1-3. Configuration of a projection plate
1-4. Display control of an image at a projection plate

2. Second embodiment
2-1. Configuration of an image projection apparatus
2-2. Application example

3. Conclusion

### 1. FIRST EMBODIMENT

[1-1. Configuration of an Image Projection Apparatus]

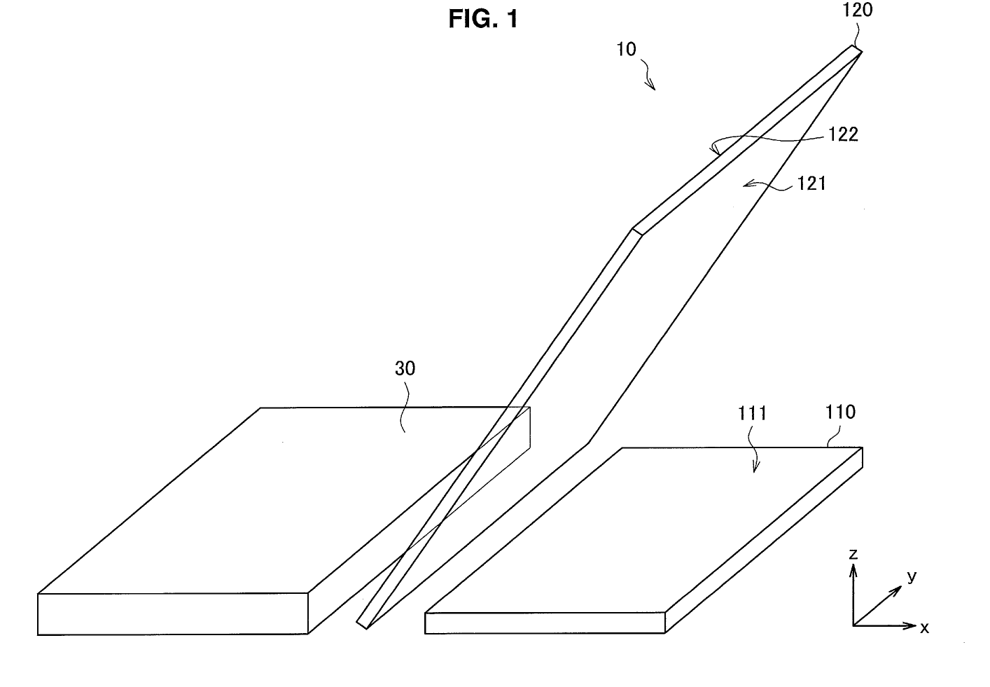

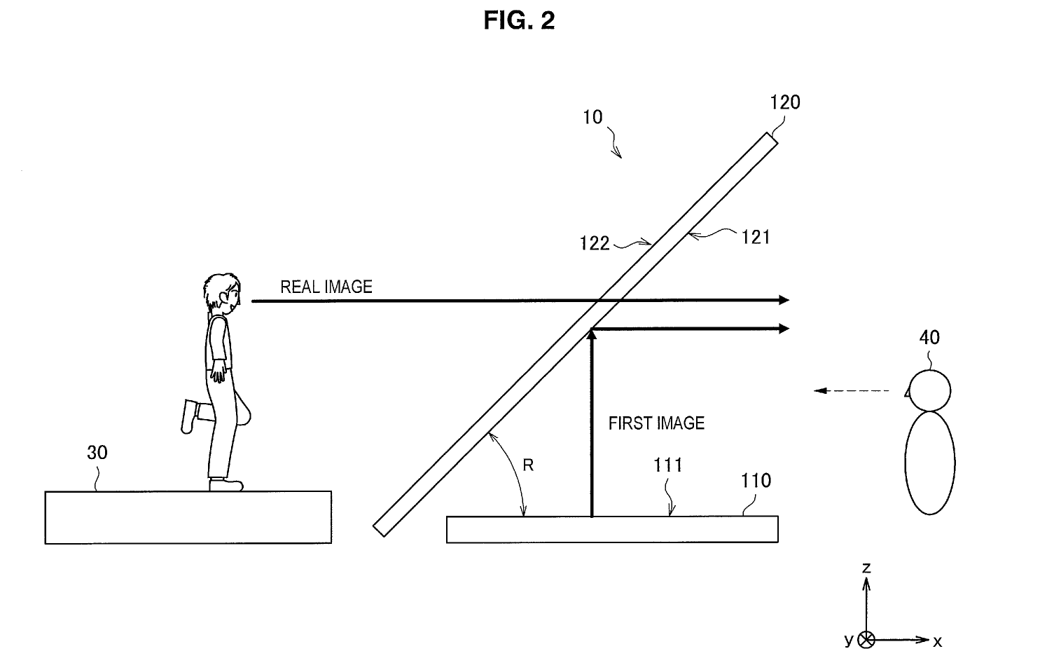

First, with reference to FIG. 1 and FIG. 2, there will be explained a configuration example of an image projection apparatus according to a first embodiment of the present disclosure. FIG. 1 is a perspective view showing a configuration example of the image projection apparatus according to the first embodiment of the present disclosure. FIG. 2 is a side view showing a state when the image projection apparatus shown in FIG. 1 is viewed from the side. Note that, in the following, as an example, there will be explained a case where the image projection apparatus according the first embodiment is applied to various kinds of attraction performed on a stage. Accordingly, each of FIG. 1 and FIG. 2 shows the stage together with the image projection apparatus according to the first embodiment. Further, FIG. 2 also shows a player playing an attraction on the stage and an audience observing the attraction performed on the stage.

With reference to FIG. 1 and FIG. 2, an image projection apparatus 10 according to the first embodiment of the present disclosure includes a display unit 110 and a projection plate 120. Further, the image projection apparatus 10 is disposed between a stage 30 and an audience 40. In this manner, in the first embodiment, the audience 40 observes an attraction on the stage 30 via the image projection apparatus 10. FIG. 2 schematically shows a visual line direction of the audience 40 by the broken arrow.

The display unit 110 is display means to display various kinds of information visually to a user in any formats such as image, a character, and a graph, and is configured with a display apparatus or the like, for example. In the following explanation, the display unit 110 is also called a display apparatus 110. Further, since an image projection apparatus according to a second embodiment of the present disclosure to be described below includes another display unit, in the following explanation, for discriminating between these plural display units, the display unit 110 shown in FIG. 1 and FIG. 2 is also called a first display unit 110 or a first display apparatus 110.

As shown in FIG. 1 and FIG. 2, the display unit 110 is placed on a floor (ground) in a state of directing upward an emission surface 111 to emit light forming an image (in the following, also described as “emits an image”). Here, in the following explanation, as shown in FIG. 1 and FIG. 2, the image emission direction of the display unit 110 (up and down direction in each of FIG. 1 and FIG. 2) is defined as a z-axis direction, the direction in which the audience 40 views the stage 30 is defined as an x-axis direction, and the direction which perpendicularly crosses the x-axis direction and the z-axis direction is defined as a y-axis direction. Further, in the z-axis direction, the direction in which a first image is emitted from the first display unit 110 is defined as the positive direction of the z-axis. Moreover, in the x-axis direction, the direction going from the stage 30 to the audience 40 is defined as the positive direction of the x-axis. Here, the emission surface 111 of the display unit 110 is a hypothetical surface where the light forming an image is emitted from the display unit 110, and indicates a surface parallel to a plane defined by the x-axis and the y-axis (x-y plane). When a display screen of the display unit 110 is a plane and a surface parallel to the x-y plane, the emission surface 111 may be the same surface as the display screen.

The first display unit 110 is configured with a display apparatus or the like capable of displaying a three-dimensional image (3D image) by a so-called polarization method, utilizing a difference in the polarization direction of the emission light from the emission surface 111. For example, the first display unit 110 may be an LED display apparatus capable of displaying a 3D image by the polarization method. Here, in the following explanation, the image displayed by the first display unit 110 is called a first image. That is, the first display unit 110 has a function of displaying the first image as a 3D image utilizing the difference in the polarization direction of the emission light. Note that the first image includes all the displays which the first display unit 110 can display on the display screen thereof For example, in the first embodiment, the first image can include not only an image but also a character, a graph, and the like.

Here, the polarization method which is a method of displaying a 3D image in a display apparatus or the like will be explained. The polarization method provides a phase difference plate or a polarization plate on the display screen and controls the polarization direction of the emission light from the display screen. At this time, the display screen is divided into two regions, and the phase difference plate, the polarization plate or the like is provided appropriately for each of the first and second regions so that light having a first polarization direction (e.g., s-polarization direction) is emitted from the first region and light having a second polarization direction (e.g., p-polarization direction) different from the first polarization direction is emitted from the second region. Instead of the s-polarization and the p-polarization, right-handed circular polarization and left-handed circular polarization may be used. Then, the first region and the second region are provided alternately for every one line of pixels of the display screen, for example (line-by-line method). For example, the phase difference plate, the polarization plate, or the like is configured appropriately in each of the pixel of an even-numbered line and the pixel of an odd-numbered line, so that the light having the first polarization direction is emitted from the pixel of the even-numbered line and the light having the second polarization direction is emitted from the pixel of an odd-numbered line among the pixel lines configuring the display screen. With such a configuration, light beams having polarization directions different from each other are emitted from the pixel of the even-numbered line and the pixel of the odd-numbered line in the display screen.

Meanwhile, a viewer views an image of the display screen in the state of wearing polarization glasses each transmitting only light having a predetermined polarization direction. Here, for the right and left eyes of the viewer, the polarization glasses are provided with phase difference plates or polarization plates so that only the light having the first polarization direction enters one of the eyes and only the light having the second polarization direction enters the other one of the eyes. Accordingly, for example, only the emission light from the pixel of the even-numbered line enters the right eye of the viewer, and only the emission light from the odd-numbered line enters the left eye of the viewer. Thereby, by controlling the display on the display screen so that an image for the right eye is displayed by the pixel of the even-numbered line and an image for the left eye is displayed by the pixel of the odd-numbered line, it is possible to cause the right and left eyes of a user to recognize the respective different images. Accordingly, by displaying images configured in consideration of user's parallax, it becomes possible to display a 3D image for the user.

In the first embodiment, the first display unit 110 may be an LED display apparatus capable of displaying a 3D image by the polarization method to which the above line-by-line method is applied. Note that, for the LED display apparatus to display a 3D image by the polarization method which is applicable as the first display unit 110, for example, it is possible to refer to JP 2012-242564A and JP 2012-252104A which are preceding patent applications by the present applicants. However, the first display unit 110 according to the first embodiment is not limited to such configurations. The polarization method in the first display unit 110 may not employ the line-by-line method, and the first display unit 110 may be configured with a display apparatus other than the LED display apparatus (e.g., liquid crystal display apparatus, organic EL display apparatus, or the like). In the first embodiment, the first display unit 110 may have a function of displaying a 3D image by the polarization method, and any of various kinds of publicly known configuration and technique of a typical display apparatus capable of displaying a 3D image by the polarization method can be applied to a specific configuration and a display control method thereof. Further, while, in FIG. 1 and FIG. 2, the detailed configuration of the first display unit 110 is omitted from illustration for simplification, the first display unit 110 may include any of various kinds of configuration employed by a publicly known typical display apparatus.

The projection plate 120 is formed by an optically isotropic material in a predetermined thickness, and the first image is projected by the first display unit 110 onto a projection surface 121 which is a surface of the projection plate 120. As shown in FIG. 1 and FIG. 2, the projection plate 120 is disposed such that the projection surface 121 is inclined at a predetermined angle R with respect to the emission surface 111 of the first image in the first display unit 110. In the example shown in FIG. 2, the predetermined angle R is defined as an angle in the plane defined by the x-axis and the z-axis (x-z plane) so that the first image projected onto the projection surface 121 is reflected in the positive direction of the x-axis. By the first display unit 110 and the projection plate 120 being disposed in this manner, the audience 40 positioned in the positive direction of the x-axis can view the first image projected onto the projection surface 121 of the projection plate 120. Note that, in the following explanation, the image projected onto the projection plate 120 is also called a projection image. Further, the projection image of the first image onto the projection plate 120 is also called a first projection image.

Note that, specifically, the angle R formed by the projection surface 121 of the projection plate 120 and the emission surface 111 of the first display unit 110 may be approximately 45 degrees. Since the first image projected from the first display unit 110 is reflected approximately perpendicularly toward the audience 40 at the projection surface 121 when the angle R is approximately 45 degrees, it is not necessary to provide any special correction for the first image, and an image approximately the same as the first image displayed on the display screen of the first display unit 110 can be recognized by the audience 40 as an image on the projection plate 120. Note that the first embodiment is not limited to such an example, and the angle R may be an angle other than approximately 45 degrees. However, when the angle R is an angle other than approximately 45 degrees, the first projection image on the projection plate 120 can be a deformed image for the audience. Accordingly, the processing of correcting the deformation of the first projection image may be performed by appropriately controlling the display of the first display unit 110 according to the value of the angle R. In this manner, in the first embodiment, the display in the first display unit 110 may be controlled appropriately according to the value of the angle R formed by the projection surface 121 of the projection plate 120 and the emission surface 111 of the first display unit 110.

Meanwhile, the projection plate 120 is formed by a material transparent for visible light, and transmits at least a part of light from a surface 122 on the opposite side of the projection surface 121. Further, as shown in FIG. 1 and FIG. 2, the projection plate 120 is disposed so that the surface 122 on the opposite side faces the stage 30. Accordingly, the projection plate 120 transmits visible light from the stage 30 from the surface 122 on the opposite side in the positive direction of the x-axis. Accordingly, the audience 40 positioned in the positive direction of the x-axis can observe a real image of a player 310 on the stage 30, an attraction performed on the stage 30 and the like through the projection plate 120. Such a real image on the stage 30 is also assumed to be a projection image onto the projection plate 120, and therefore the “projection image” mentioned in the first embodiment also includes the real image on the stage 30. Note that, in the following explanation, since transmitting the real image on the stage 30 in the positive direction of the x-axis, the surface 122 on the opposite side of the projection surface 121 with respect to the projection plate 120 is also conveniently called a transmission surface 122.

Further, as described above, the projection plate 120 is formed by an optically isotropic material in a predetermined thickness. For example, the projection plate 120 is formed by an acryl resin which is an optically isotropic material. When the projection plate 120 is formed by the acryl-based resin, the refractive index thereof is approximately 1.49. However, the material of the projection plate 120 according to the present embodiment is not limited to such an example, and the projection plate 120 may be formed by another material if the material is optically isotropic. For example, the projection plate 120 may be formed by any of various kinds of glass or a composite material of polycarbonate and acryl which are optically isotropic materials.

Further, specifically the projection plate 120 is formed in a thickness of approximately 1 mm to 5 mm, for example. More preferably, the thickness of the projection plate 120 is approximately 2 mm. If the thickness of the projection plate 120 is smaller than 1 mm, there is a possibility that the projection plate 120 could be bent and broken when disposed to be inclined at a predetermined angle R with respect to the emission surface 111 of the first display unit 110 as shown in FIG. 1 and FIG. 2, depending on the material thereof. Further, also if the thickness of the projection plate 120 is not larger than 1 mm, there is a possibility that a predetermined surface accuracy is not kept in a manufacturing process, depending on the material thereof. Moreover, if the thickness of the projection plate 120 is further smaller, for example, not larger than several microns, there is a possibility that light interference may be caused between the reflection light from the projection surface 121 and the reflection light from the transmission surface 122 of the projection plate 120 when the first image is projected from the first display unit 110, and light interference may be caused between the reflection light from the transmission surface 122 and the reflection light from the projection surface 121 of the projection plate 120 when the light from on the stage 30 (i.e., real image) is projected. Such bending, breakage, surface accuracy degradation, and interference occurrence result in the quality degradation of the projection image at the projection plate 120. Accordingly, the projection plate 120 may be formed so as to have a thickness to such a degree as the bending or the breakage is not caused when disposed to be inclined at a predetermined angle R with respect to the emission surface 111 of the first display unit 110. Further, the projection plate 120 may be formed so as to have a thickness to such a degree as the light interference between the reflection light from the projection surface 121 and the reflection light from the transmission surface 122 of the projection plate 120 may not be generated when the first image is projected from the first display unit 110. Further, the projection plate 120 may be formed so as to have a thickness to such a degree as a predetermined surface accuracy may be kept in the manufacturing process from the viewpoint of the quality of the projection image (image quality).

Further, if the thickness of the projection plate 120 is larger than 5 mm, there is a possibility that light paths in the positive direction of the x-axis are shifted in the reflection light from the projection surface 121 and the reflection light from the transmission surface 122 of the projection plate 120, and the first projection image might be observed by the audience as a double image (blurred image) when the first image is projected from the first display unit 110. Accordingly, the thickness of the projection plate 120 may be determined so as to suppress such a phenomenon that the first projection image is observed overlappingly. Note that whether or not the first projection image is observed overlappingly by the audience depends on the refractive index of the material of the projection plate 120 and a pixel interval in the emission surface of the first display unit 110. Accordingly, in the first embodiment, the thickness of the projection plate 120 may be determined based on at least the refractive index of the material of the projection plate 120 and the pixel interval in the emission surface of the first display unit 110. The thickness design method of the projection plate 120 will be explained in detail in following [1-3. Configuration of a projection plate].

As above, the outline configuration of the image projection apparatus 10 according to the first embodiment of the present disclosure has been explained with reference to FIG. 1 and FIG. 2. As explained above, the image projection apparatus according to the first embodiment includes the first display unit 110 which displays the first image as a 3D image by the polarization method and the projection plate 120 which is formed by an optically isotropic material in a predetermined thickness and onto which the first image is projected by the first display unit 110. Further, in the projection plate 120, the projection surface 121 onto which the first image is projected is disposed to be inclined at a predetermined angle with respect to the emission surface 111 of the first image in the first display unit 110 and also at least a part of the light from the surface on the opposite side of the projection surface 121 is transmitted. Accordingly, the first image of a 3D image displayed by the first display unit 110 is projected onto the projection surface 121 of the projection plate 120 and reflected in the positive direction of the x-axis while keeping the polarization direction of the light forming the first image. Further, the real image on the stage 30 is transmitted in the positive direction of the x-axis through the transmission surface 122 which is a surface on the opposite side of the projection surface 121 with respect to the projection plate 120. Accordingly, the audience 40 positioned in the positive direction of the x-axis can observe an image in which the first projection image of a 3D image projected from the first display unit 110 onto the projection surface 121 and the real image transmitted through the transmission surface 122 are superimposed. Accordingly, it becomes possible to provide an audience with an image having more presence and also to provide a wider variety of image expressions. Note that, in the following explanation, each of the images which are displayed at the projection plate 120 and can be observed by the audience 40 and the image in which these images are superimposed is called an image at the projection plate 120, an image on the projection plate 120, or the like. Further, a specific example of the image at the projection plate 120 which is observed by the audience 40 will be explained in detail in following [1-2. Application example].

Here, there will be explained a result of the study performed by the present inventors about an image projection apparatus having a conventional configuration as shown in above Patent Literature 1. In the conventional image projection apparatus, an image is projected from a projector onto a screen formed by a foil (thin plate) or a film (thin film) (in the following, called a foil or film screen). Further, the foil or film screen has a feature that the screen is formed thin to such a degree as is wound around a cylinder.

First, the present inventors studied the brightness of the projection image on the foil or film screen in the conventional configuration. Generally, it is known that the brightness of emission light from the projector is approximately 2,000 to 10,000 lumens (lm). Since an image displayed to an audience is formed by a reflection light component of the light emitted from the projector at the foil or film screen, the brightness of the image actually observed by the audience becomes further smaller than the above value (2,000 to 10,000 (lm)). For example, in the case where the light having a brightness of approximately 10,000 (lm) is emitted from the projector and projected onto the screen having a size of 100 inches, it is known that the brightness of the image on the screen is approximately 100 (nt) when expressed by nit (nt:nit, nt=cd/m²) which is a unit to express the brightness of surface light emission. Moreover, since 3D image display is presented to the audience dividing the image on the display screen spatially or temporally into an image for the right eye and an image for the left eye, it is generally known that a 3D image becomes darker than a two-dimensional image (2D image) when displayed by the same apparatus. Accordingly, when a 3D image is to be projected from the projector in the conventional configuration as shown in above Patent Literature 1, the brightness of the projection image becomes further darker. From the above situation, it is difficult to secure a sufficient brightness of the projection image in the conventional configuration. Therefore, also the brightness of lighting to illuminate the stage needs to be comparatively low for having consistency with the brightness of the projection image, and there is a possibility that the staging of an attraction performed on the stage is limited in the point of brightness.

Next, the present inventors studied a change in the polarization direction of the projection image projected onto the foil or film screen in the conventional configuration. When an image is projected onto the foil or film screen, there is a possibility that the polarization directions of the transmission light and the reflection light are disturbed depending on the material of the foil or film screen. The present inventors performed an experiment to study the polarization directions of the transmission light and the reflection light, by emitting light onto a screen using a thin film screen employed in a typical conventional image projection technique for space projection. As the result of the experiment, a change in the polarization direction was confirmed between the emission light and each of the transmission light and the reflection light at the screen. Therefore, there is a fear that the polarization direction of the projected image is changed and the projection image is not displayed as a 3D image when the 3D image is to be projected on to the screen by the polarization method.

Moreover, the present inventors studied a configuration of using an LED display apparatus instead of the projector in the above conventional configuration. In this configuration, an image is projected onto a foil or film screen from the LED display apparatus. Here, as described above, the foil or film screen is formed thin to such a degree as is wound around a cylinder. When monochromatic light as emitted from an LED (i.e., light having a narrow wavelength band) is irradiated onto such a thin film foil or film screen, there is a concern that a interference fringe might be caused by reflection at the surface and the rear surface thereof. The present inventors performed an experiment to study the light interference on the screen, by irradiating light onto the screen using a thin film screen employed in the typical conventional image projection technique for space projection. As the result of the experiment, the interference fringes on the screen were confirmed for each of the transmission light and the reflection light at the screen. Therefore, there is a possibility that the interference fringes are caused on the screen and the quality of the projection image is degraded in the configuration in which an image is projected onto the conventional foil or film screen from the LED display apparatus.

On the other side, as explained above, the image projection apparatus 10 according to the first embodiment of the present disclosure includes the first display unit 110 to display the first image as a 3D image by the polarization method and the projection plate which is formed by an optically isotropic material in a predetermined thickness and onto which the first image is projected by the first display unit 110. Here, the first display unit 110 may be an LED display apparatus. In a business-use LED display apparatus used for an event and the like, the brightness of the emission light from the display screen thereof reaches approximately 2,000 (nt). Here, as described above, when light having a brightness of approximately 10,000 (lm) is emitted from the projector to project an image onto a screen having a size of 100 inches, the brightness of the image on the screen is approximately 100 (nt). In this manner, in the first embodiment, by using the LED display apparatus capable of emitting a brighter light as the first display unit 110, it is possible to increase the brightness of the projection image onto the projection plate 120 compared with the case of emitting light from the projector. Further, by using the LED display apparatus capable of emitting a brighter light than the projector as the first display unit 110, it is possible to keep the brightness of the projection image onto the projection plate 120, even when the first image projected onto the projection plate 120 is a 3D image. Accordingly, in the first embodiment, the restriction for the brightness of the lighting in an attraction performed on the stage is relaxed, and it becomes possible to perform a wider variety of staging for the attraction.

Further, in the first embodiment, since the projection plate 120 is formed by an optically isotropic material which does not change the polarization directions of the reflection light and the transmission light, the disturbance of the polarization direction in the first image caused by the reflection at the projection plate 120 is suppressed when the first image is projected onto the projection plate 120. Therefore, the first projection image can be presented to the audience 40 as a 3D image having a high quality. Accordingly, it becomes possible to provide the audience with an image having more presence, and also to provide a variety of image expressions. Further, in the polarization method used in the first embodiment, the configuration of the glasses for an 3D image (3D glasses) worn by the viewer is simple and the 3D glasses can be manufactured at a low cost compared with another method such as a time division method and a color separation method. Accordingly, by using a display apparatus to display a 3D image by the polarization method as the first display unit 110, as in the first embodiment, in the situation that a large audience exists as in an attraction performed on the stage, it becomes possible to provide the audience with a 3D image at a lower cost. Further, in the time division method, it is necessary to operate a shutter provided in the 3D glasses so as to block the right and left views of the viewer alternately in response to the image display, and the timing synchronization of the shutter operation in the 3D glasses is configured to be secured by communication using infrared light or the like between the 3D glasses and a display apparatus to display the 3D image, for example. Accordingly, in the situation as a large audience observes the stage in all the directions, it is difficult to stably perform the communication for the synchronization as described above, and it might be difficult to obtain a 3D image having a high quality by the time division method. On the other side, in the polarization method used in the first embodiment, it is not necessary to use the communication for the synchronization as described above. Accordingly, in the first embodiment, it becomes possible to provide the audience with the first projection image stably as a 3D image.

Moreover, in the first embodiment, for example, the thickness of the projection plate 120 is approximately 1 mm to 5 mm, and more preferably approximately 2 mm, and designed so as to have a thickness to such a degree as the light interference between the reflection light at the projection surface 121 and the reflection light at the transmission surface 122 when the first image is projected from the first display unit 110. Accordingly, even when the first image is projected by a display apparatus in which a light source, such as the LED display apparatus, emits monochrome light, the generation of the interference fringes is suppressed at the projection plate 120. Accordingly, it becomes possible to provide the audience 40 with an image having a high quality as the first projection image.

[1-2. Application example]

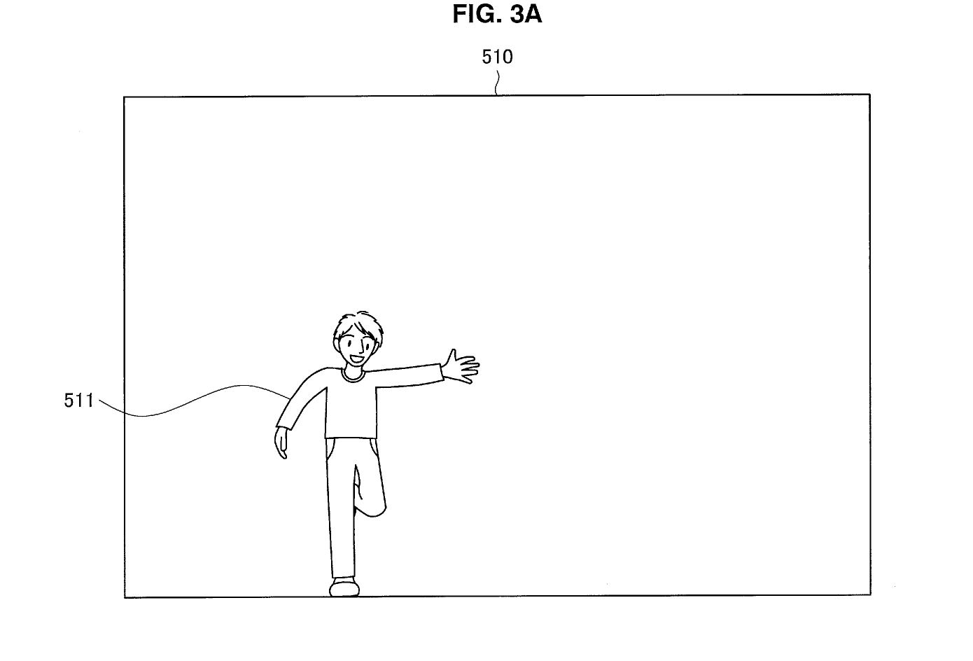

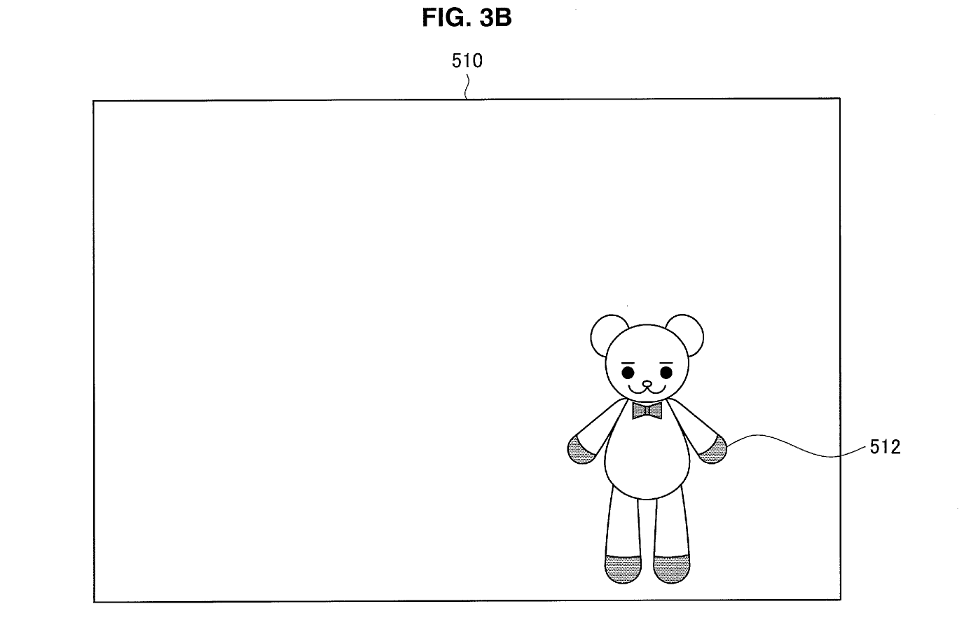

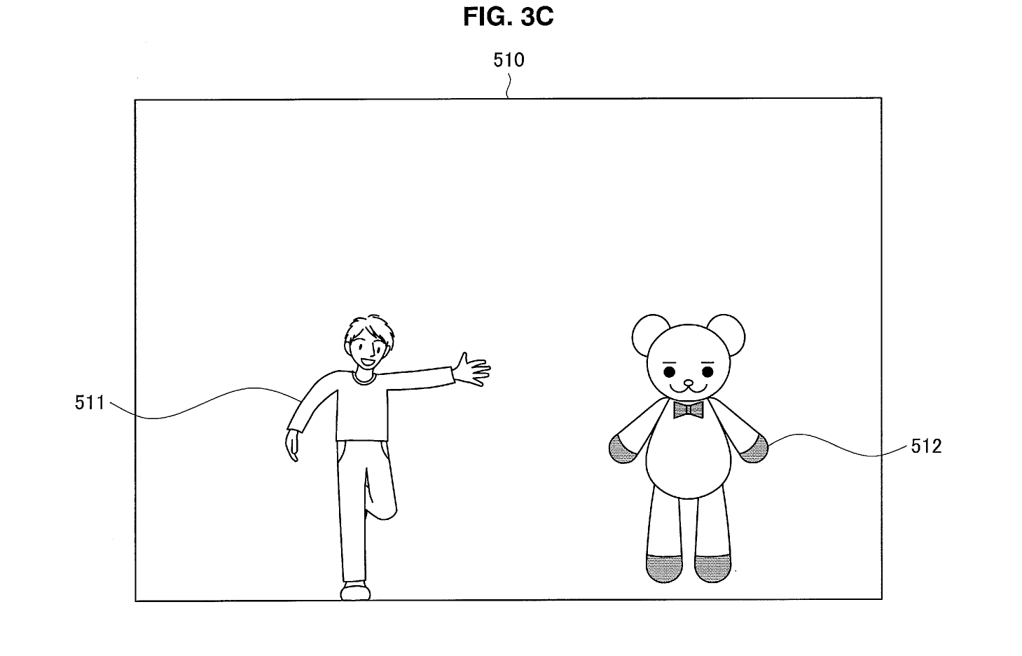

Next, there will be explained an application example of the image projection apparatus 10 according to the first embodiment with reference to FIG. 3A to FIG. 3C. FIG. 3A to FIG. 3C are explanatory diagrams for explaining an application example of the image projection apparatus 10 according to the first embodiment. FIG. 3A to FIG. 3C schematically show an image on the projection plate 120 observed by the audience 40 when the image projection apparatus 10 according to the first embodiment is applied to an attraction (e.g., drama) performed on the stage 30. That is, FIG. 3A to FIG. 3C express the views of the audience 40 in the state that the audience 40 in FIG. 1 and FIG. 2 observes the stage 30 through the projection plate 120 from a position in the positive direction of the x-axis.

FIG. 3A shows an real image on the stage 30 which is observed by the audience 40. With reference to FIG. 3A, a real image 511 is displayed in a display region 510. The real image 511 is the player 310 shown in FIG. 1 and FIG. 2, for example. Further, FIG. 3A corresponds to an image on the projection plate 120 observed by the audience 40 when the first display unit 110 does not display the first image. In this case, since the first image is not projected to the projection plate 120 from the first display unit 110, the audience 40 can observe the real image 511 which is an object on the stage 30, through the projection plate 120.

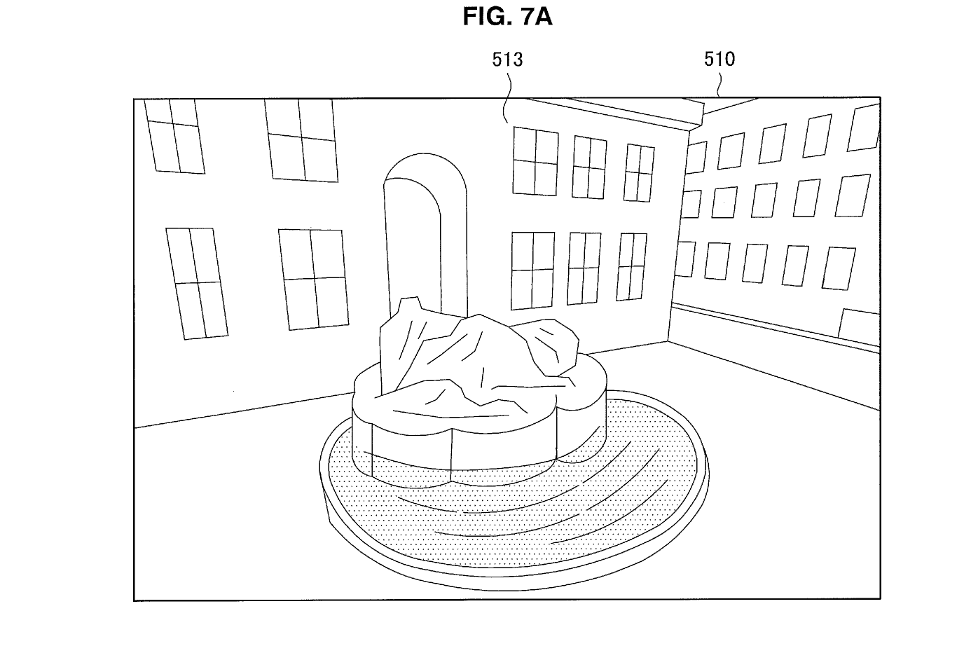

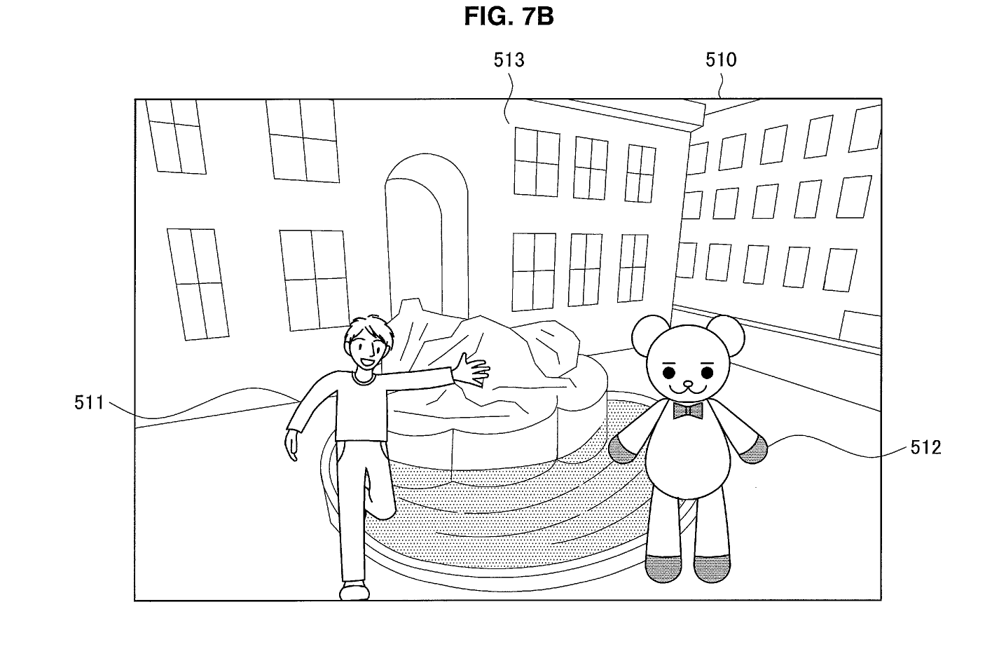

Note that the display region 510 shows a predetermined region in the view of the audience 40 including at least the projection image to the projection plate 120, for convenience. In the following, each of FIG. 3B and FIG. 3C, and also FIG. 7A and FIG. 7B to be described below also illustrates the display region 510 having the same concept, and explanation will be given using an image in the display region 510 as an example.

FIG. 3B shows a first projection image 512 to be observed by the audience 40 which is projected to the projection plate 120 from the first display unit 110. With reference to FIG. 3B, the first projection image 512 of a 3D image is displayed in the display region 510. In the example shown in FIG. 3B, the first projection image 512 is an image of a character imitating a bear and may be an animation image with motion, for example. Note that, in FIG. 3B, only the first projection image 512 is illustrated and the object on the stage 30 to be observed actually by the audience 40 is omitted from illustration, for convenience of explanation.

FIG. 3C shows an image on the projection plate 120 which is actually observed by the audience 40 when the first display unit 110 displays the first image. With reference to FIG. 3C, the real image 511 and the first projection image 512 are displayed together in the display region 510. In this manner, FIG. 3C corresponds to an image in which the image in the display region 510 shown in FIG. 3A and the image in the display region 510 shown in FIG. 3B are combined. The audience 40 can observe the real image 511 on the stage 30 through the projection plate 120 and also can observe the first projection image 512 projected onto the projection plate 120 from the first display unit 110.

As above, an application example of the image projection apparatus 10 according to the first embodiment has been explained with reference to FIG. 3A to FIG. 3C. As explained above, in the first embodiment, the audience 40 can observe the real image 511 existing on the other side of the projection plate 120 through the projection plate 120 (e.g., object on the stage 30) and also can observe the first projection image 512 which is a 3D image projected onto the projection plate 120 from the first display unit 110. Accordingly, the audience is provided with an image on the projection plate 120 in which the real image 511 (e.g., player on the stage) and the first projection image 512 (e.g., animation character) are combined, and thereby it becomes possible to perform a variety of image expressions. Further, since the first projection image 512 is displayed as a 3D image, it becomes possible to provide the audience 40 with an image having more presence.

[1-3. Configuration of a Projection Plate]

Next, the configuration of the projection plate 120 in the image projection apparatus 10 will be explained in more detail. As described above, the projection plate 120 is formed by an optically isotropic material in a predetermined thickness. Here, there will be explained a design concept to determine the thickness of the projection plate 120.

In the first embodiment, the thickness of the projection plate 120 can be determined by various parameters. For example, as described above, the projection plate 120 is formed so as to have a thickness to such a degree as bending or breakage is not caused when disposed to be inclined at a predetermined angle with respect to the emission surface of the first display unit 110 as shown in FIG. 1 and FIG. 2. If the bending or breakage is caused in the projection plate 120, distortion or a defect is caused in the projection image onto the projection plate 120 by the bending or the breakage, which might be a cause of the image quality degradation of the projection image which is projected onto the projection plate 120 to be presented to the audience. Since whether such bending or breakage is caused or not relates to the strength and the toughness of the projection plate 120, the thickness of the projection plate 120 may be determined based on a parameter such as the Young's modulus and the toughness value of the material.

Further, the projection plate 120 may have a thickness to such a degree as the light interference is not generated between the reflection light from the projection surface 121 and the reflection light from the transmission surface 122 of the projection plate 120 when the first image is projected from the first display unit 110 or when the light from the stage 30 (i.e., light from the real image) is projected. If the interference fringe or the like by the light interference is observed in the projection plate 120, it might be a cause of quality degradation of the projection image onto the projection plate 120. Since such an interference relates to the wavelength band of the light included in the projected first image or the light from the stage 30, the thickness of the projection plate 120 may be determined in a range where the interference generated in light of a visible light wavelength band does not affect the quality of the projection image onto the projection plate 120, for example.

Further, the projection plate 120 may have a thickness to such a degree as keeping a predetermined surface accuracy in the manufacturing process. Sometimes, it is difficult to keep the surface accuracy to be not higher than a predetermined value when the projection plate 120 is formed thinner, depending on the material or the manufacturing method of the projection plate 120. When the surface accuracy of the projection plate 120 becomes larger than the predetermined value (becomes rough), the reflection direction and the refraction direction of light at the projection surface 121 and the transmission surface 122 do not become uniform in the surface, which might be a cause of the quality degradation of the projection image onto the projection plate 120. Accordingly, the thickness of the projection plate 120 may be determined in a range where it is possible to keep surface accuracy enough for the projection image onto the projection plate 120 to have a predetermined quality, depending on the material and the manufacturing method of the projection plate 120, for example.

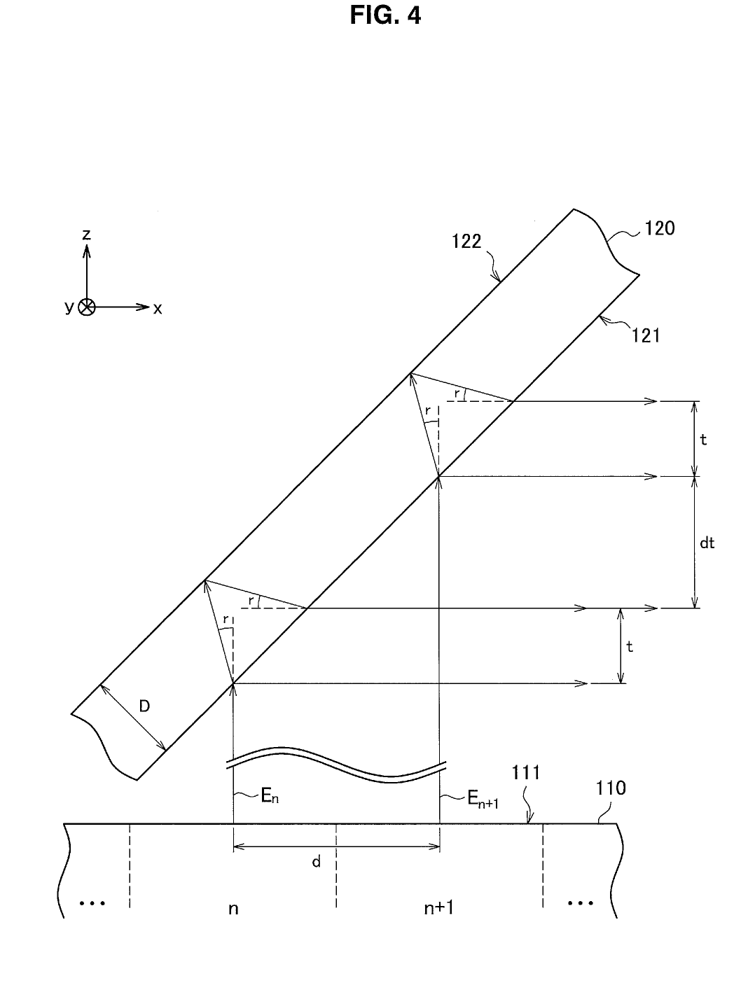

Further, the thickness of the projection plate 120 may be determined based on at least the refractive index of the material of the projection plate 120 and the pixel interval in the emission surface of the first display unit 110. Such a design method for the thickness of the projection plate 120 will be explained in detail with reference to FIG. 4.

FIG. 4 is an explanatory diagram for explaining a method of determining the thickness of the projection plate 120 according to the first embodiment. FIG. 4 corresponds to a diagram in which a part of the projection plate 120 is extracted and enlarged in the side view of the image projection apparatus 10 shown in FIG. 2. Further, FIG. 4 illustrates a part of the first display unit 110 which corresponds to the extracted part of the projection plate 120 at the same time. Further, the region indicated by “n” or “n+1” in the first display unit 110 shows a region corresponding to each pixel configuring the display screen of the first display unit 110 in the emission surface 111 of the first display unit 110. FIG. 4 focuses on one pixel line in a pixel array configuring the display screen of the first display unit 110, and the region denoted by “n” shows a region corresponding to the nth pixel (n is any integer smaller than the number of pixels in the line) in the pixel line (in the following, called a region n) and the region denoted by “n+1” shows a region corresponding to the (n+1)-th pixel in the pixel line (in the following, called a region n+1).

Further, the arrow extended in the z-axis direction from the region n schematically shows a light path of emission light Eₙ emitted from the nth pixel when the first image is displayed. Similarly, the arrow extended in the z-axis direction from the region n+1 schematically shows a light path of emission light Eₙ+1 emitted from the (n+1)-th pixel when the first image is displayed. In the first embodiment, since the first display unit 110 is an LED display apparatus, and each pixel is configured with a plurality of LEDs (e.g., red (R), green (G), and blue (B) LEDs), actually the light emitted by each pixel should be emitted having a predetermined spread. However, FIG. 4 schematically shows the the representative traveling direction of the light emitted by each of the nth pixel and the (n+1)-th pixel by one arrow.

Further, in FIG. 4, the thickness of the projection plate 120 is defined as a thickness D, and the pixel interval in the emission surface 111 of the first display unit 110 is defined as a pixel interval d. Further, in the example shown in FIG. 4, the angle R formed by the projection surface 121 of the projection plate 120 and the emission surface 111 of the first display unit 110 is assumed to be 45 degrees.

With reference to FIG. 4, the emission light Eₙ from the region n travels through the light path shown by the arrow in the positive direction of the z-axis, and is irradiated onto the projection surface 121 of the projection plate 120. A part of the emission light Eₙ is reflected at the projection surface 121 approximately perpendicularly, and travels approximately in the positive direction of the x-axis. Further, a part of the emission light Eₙ enters the projection plate 120 and is also refracted at a predetermined angle r to reach the transmission surface 122. The light having reached the transmission surface 122 is reflected by the transmission surface 122 and refracted again by the interface between the projection plate 120 and the outer space (air) at the predetermined refraction angle r to travel approximately in the positive direction of the x-axis. Accordingly, toward the audience positioned in the positive direction of the x-axis, in the emission light Eₙ from the region n, the component reflected by the projection surface 121 and the component reflected by the transmission surface 122 travel shifted by a spacing t. In this manner, by the audience observing the projection plate 120 from a position in the positive direction of the x-axis, the emission light Eₙ from the region n can be observed as double light shifted by the spacing t.

Similarly, for the emission light Eₙ₊₁ from the region n+1, a component reflected by the projection surface 121 and a component reflected by the transmission surface 122 travel toward the audience positioned in the positive direction of the x-axis in a state of being shifted by the spacing t. Since the same phenomenon is considered to occur for all the pixels, the audience observing the projection plate 120 observes two first projection images displayed on the projection plate 120 at shifted positions in a state of being superimposed double. If this shift amount is large enough to be recognized by the audience, the audience observes an unclear image having a blurred contour as the first projection image.

Further, as shown in FIG. 4, the spacing between the component reflected by the transmission surface 122 in the emission light Eₙ from the region n and the component reflected by the projection surface 121 in the emission light Eₙ₊₁ from the region n+1 can be expressed by a spacing dt for convenience. As described above, the arrow shown in FIG. 4 shows the traveling direction of the light representatively, and the actual light is considered to travel in the direction of each of the arrows having a predetermined spread. Accordingly, if the value of the spacing dt is too small, the overlap between the emission light Eₙ and the emission light Eₙ₊₁ from the neighboring pixels increases, which may also cause the situation that the audience observes the first projection image in a state of being superimposed double.

Accordingly, in the first embodiment, preferably each of the spacing t and the spacing dt defining a position shift amount of the first projection image on the projection plate 120 is suppressed to have a value smaller than a predetermined threshold value with which the audience can recognize the shift amount (in the following, the threshold value of the spacing t is called a threshold value Tₜ and the threshold value of the spacing dt is called a threshold value T_{dt}). With reference to FIG. 4, the spacing t and the spacing dt are determined based on the thickness D of the projection plate 120 and the angle r of the refraction angle. Further, the spacing dt is determined further based on the pixel interval d. Moreover, the spacing t and the spacing dt also depend on the wavelengths of the emission light Eₙ and the emission light Eₙ₊₁. Accordingly, the thickness D of the projection plate 120 may be determined so that the spacing t and the spacing dt become smaller than the threshold value Tₜ and the threshold value T_{dt}, respectively, in a range satisfying the the above condition for the strength, the toughness, the interference, the surface accuracy, and the like, based on the parameters such as the refractive index (i.e., angle r of the refraction angle) of the projection plate 120, the wavelength band of the light included in the first image, and the pixel interval d in the emission surface 111. Note that the threshold value Tₜ and the threshold value T_{dt} may be set as the limit values of the spacing t and the spacing dt where the first projection image can be observed double by the audience, and may be set based on the subjectivity of the audience or a situation of applying the image projection apparatus 10. For example, the threshold value Tₜ and the threshold value T_{dt} may be set based on the distance between the audience and the projection plate 120 or the brightness of the first image or the lighting to illuminate the stage. For example, when the distance between the audience and the projection plate 120 is comparatively small, or the brightness of the first image or the lighting to illuminate the stage is comparatively high, the audience is considered likely to respond sensitively to the shift of the first projection image, and therefore the threshold value Tₜ and the threshold value T_{dt} may be set to comparatively small values. On the other hand, when the distance between the audience and the projection plate 120 is comparatively large or the brightness of the first image or the lighting to illuminate the stage is comparatively low, the audience is considered unlikely to recognize the shift of the first projection image, and therefore the threshold value Tₜ and the threshold value T_{dt} may be set to comparatively large values. In this manner, the threshold value Tₜ and the threshold value T_{dt} of the spacing t and the spacing dt for determining the thickness D of the projection plate 120 may be set appropriately in consideration of the subjectivity of the audience depending on the situation of applying the image projection apparatus 10.

Here, when, as a specific configuration example of the image projection apparatus 10 according to the first embodiment, acryl-based resin (refractive index: approximately 1,49) is used as the material of the projection plate 120 and an LED display apparatus having a pixel interval of approximately 4 mm (in more detail, approximately 4.4 mm) in the emission surface is used as the first display unit 110, by setting the thickness of the projection plate 120 to approximately 2 mm (i.e., approximately a half of the pixel interval), it was confirmed that a preferable projection image can be obtained.

Further, as described above, while the conditions for the strength, the toughness, the interference, the surface accuracy, and the like which are the parameters for determining the thickness of the projection plate 120 can be determined based on the quality of the projection image onto the projection plate 120, also the quality of the projection image onto the projection plate 120 may be set based on the subjectivity of the audience observing the projection image or the situation of applying the image projection apparatus 10. For example, the quality required for the projection image onto the projection plate 120 is considered to change variously depending on the situation in which the audience observes the projection image onto the projection plate 120, that is, the situation of applying the image projection apparatus 10 (e g , kinds or contents of attractions performed on the stage 30). Accordingly, the thickness of the projection plate 120 may be determined so that the projection image onto the projection plate 120 keeps a predetermined quality according to the situation of applying the image projection apparatus 10 and the situation in which the audience observes the projection image, based on the conditions for the strength, the toughness, the interference, the surface accuracy, and the like.

[1-4. Display Control of an Image at a Projection Plate]

Next, the display control of the image at the projection plate 120 will be explained in more detail. As explained with reference to FIG. 1 and FIG. 2, in the first embodiment, an image finally observed by the audience is the image displayed on the projection plate 120. Accordingly, the display control of the image displayed on the projection plate 120 may be performed according to the configuration of the projection plate 120 so as to present the image displayed on the projection plate 120 appropriately to the audience. Specifically, the display state of the image at the projection plate 120 may be controlled according to the refractive index of the material of the projection plate 120 and the angle R formed between the projection surface 121 of the projection plate 120 and the emission surface 111 of the first display unit 110.

Here, in the first embodiment, the first image displayed by the first display unit 110 is projected onto the projection plate 120, and displayed on the projection plate 120 as the first projection image. Accordingly, in the first embodiment, the display state of the image at the projection plate 120 is controlled according to the display control in the first display unit 110. Therefore, actually, the image display at the projection plate 120 may be controlled by appropriate display control of the first image in the first display unit 110 according to the configuration of the projection plate 120.

Specifically, the reflectance of the first image at the projection surface 121 of the projection plate 120 changes according to the refractive index of the material of the projection plate 120 and the angle R formed by the projection surface 121 of the projection plate 120 and the emission surface 111 of the first display unit 110. When the reflectance is comparatively high, since the ratio of light to travel toward the audience in the light included in the first image is large, the audience can observe the first projection image as a comparatively bright image. Accordingly, in this case, the brightness when the first display unit 110 displays the first image may be controlled to have a comparatively low value. On the other hand, when the reflectance is comparatively low, since the ratio of light to travel toward the audience in the light included in the first image is small, the brightness of the first projection image observed by the audience becomes comparatively low. Accordingly, in this case, the brightness when the first display unit 110 displays the first image may be controlled to have a comparatively high value.

In this manner, in the first embodiment, the brightness when the first display unit 110 displays the first image is controlled according to the reflectance of the first image at the projection plate 120 which is determined based on the refractive index of the material of the projection plate 120 and the angle R formed by the projection surface 121 of the projection plate 120 and the emission surface 111 of the first display unit 110, and thereby the image display at the projection plate 120 may be controlled.

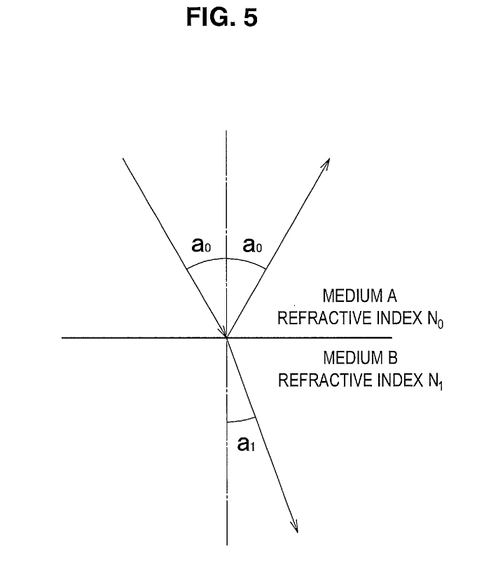

Here, with reference to FIG. 5, the reflectance of the first image at the projection plate 120 will be explained in more detail. FIG. 5 is an explanatory diagram for explaining the reflectance of the first image at the projection plate 120.

FIG. 5 is a diagram showing the reflection and the refraction of light at the interface between different kinds of medium, and shows the traveling direction of light schematically by an arrow. With reference to FIG. 5, light travelling through a medium A having a refractive index of N₀ enters the interface with a medium B having a refractive index of N₁ at an incident angle a₀. A part of the incident light is reflected by the interface at a reflection angle a₀ which is the same angle as the incident angle. Further, a part of the incident light is refracted by the interface at a refraction angle a₁ and travels in the medium B. The example shown in FIG. 5 illustrates the magnitude relationship in the refractive index between the media A and B as N₀<N₁, and the magnitude relationship between the incident angle a₀ and the refraction angle a₁ as the incident angle a₀> the refraction angle a₁.

Here, it is known that the refractive index N₀, the refractive index N₁, the incident angle a₀, and the refraction angle a₁ have a relationship so-called the Snell's law shown in following formula (1).

### [Math. 1]

N₁ sin α₁=N₀ sin α₀ (1)

Further, the reflectance I₀ in the normal incidence (i.e., a₀=a₁=0 degrees) is described by following formula (2). Here, the transmittance in the normal incidence can be calculated as 1−Iᵣ.

$$\begin{matrix}[ Math . 2 ] & \\ {I}_{r} = {( \frac{{N}_{0} - {N}_{1}}{{N}_{0} + {N}_{1}} )}^{2} & ( 2 )\end{matrix}$$

Further, the reflectance in oblique incidence (i.e., 0 degrees <a₀<90 degrees) is different between a p-polarization component and an s-polarization component. The reflectance Iₚ of the p-polarization component and the reflectance Iᵣₛ of the s-polarization component are described by following formulas (3) and (4). Here, the transmittance of the p-polarization component and the transmittance of the s-polarization component in the oblique incidence can be calculated as 1−Iᵣₚ and 1−Iᵣₛ, respectively.

$$\begin{matrix}[ Math . 3 ] & \\ {I}_{rp} = {( \frac{{N}_{0} cos {a}_{1} - {N}_{1} cos {a}_{0}}{{N}_{0} cos {a}_{1} + {N}_{1} cos {a}_{0}} )}^{2} & ( 3 ) \\ {I}_{rs} = {( \frac{{N}_{0} cos {a}_{0} - {N}_{1} cos {a}_{1}}{{N}_{0} cos {a}_{0} + {N}_{1} cos {a}_{1}} )}^{2} & ( 4 )\end{matrix}$$

Here, when the medium A is assumed to be air and the medium B is assumed to be the material of the projection plate 120 in FIG. 5, FIG. 5 can be assumed to schematically show the behavior of the emission light onto the projection plate 120 from the first display unit 110 in the image projection apparatus 10 according to the first embodiment. Accordingly, it becomes possible to simply analyze the behaviors of the incident light projected onto the projection plate 120 from the the first display unit 110 in the image projection apparatus 10, and the reflection light, and the refraction light thereof, by using above formulas (1) to (4).

For example, N₀≈1.0 is substituted for the refractive index of the air and N₁≈1.49 is substituted for the refractive index of the acryl-based resin in above formulas (1) to (4). Further, the value of the angle R formed by the projection surface 121 of the projection plate 120 and the emission surface 111 of the first display unit 110 shown in FIG. 1 and FIG. 2 (e.g., 45 degrees) is substituted for the incident angle a₀. Under these conditions, the value of the refraction angle a₁ can be calculated from above formula (1). Further, since the incidence to the projection plate 120 from the first display unit 110 is the oblique incidence when a₀=45 degrees, the reflectance Iᵣₚ and reflectance Iᵣₛ of the first image at the projection surface 121 in the oblique incidence can be calculated from above formulas (3) and (4) using the calculated value of the refraction angle a₁.

With reference to FIG. 2, since each of the reflectances Iᵣₚ and Iᵣₛ is an index indicating a reflection ratio of the light included in the first image toward the audience 40, the brightness of the first projection image observed by the audience 40 becomes comparatively high as the values of the reflectances Iᵣₚ and Iᵣₛ become large, and the brightness of the first projection image observed by the audience 40 becomes comparatively low as the values of the reflectances Iᵣₚ and Iᵣₛ become small. Further, when the difference between the reflectance Iᵣₚ of the p-polarization component and the reflectance Iᵣₛ of the s-polarization component is large, since a large difference is caused between the brightness of the p-polarization component and the brightness of the s-polarization component in the light reflected toward the audience 40, there is a possibility that the first projection image is not displayed appropriately as a 3D image.

Accordingly, in the first embodiment, the display of the image at the projection plate 120 may be controlled according to at least any of the reflectances Iᵣ, Iᵣₚ, and Iᵣₛ of the first image at the projection surface 121 calculated from above formulas (2) to (4). Specifically, the brightness of the first projection image at the projection plate 120 may be controlled by the brightness control when the first display unit 110 displays the first image according to at least any of the reflectances Iᵣ, Iᵣₚ, and Iᵣₛ of the first image at the projection surface 121. Further, the brightness of the first projection image at the projection plate 120 may be controlled according to the real image (e.g., object on the stage 30 shown in FIG. 1 and. FIG. 2) to be observed by the audience through the projection plate 120. For example, the brightness of the first projection image at the projection plate 120 is adjusted according to the brightness of the lighting to illuminate the real image on the stage 30. Since the image observed by the audience is an image in which the real image on the stage 30 and the first projection image on the projection plate 120 are combined, by the adjustment of the brightness of both images to the same level, a natural image providing the feeling of more unity is presented to the audience. Further, depending on the staging of the attraction performed on the stage 30, a large difference may be provided on purpose between the brightness of the lighting to illuminate the real image on the stage 30 and the brightness of the first projection image at the projection plate 120. Further, the display control of the image at the projection plate 120 may be performed dynamically according to the contents or progress of the attraction.

As above, with reference to FIG. 5, the display control of the image at the projection plate 120 in the first embodiment has been explained. As explained above, in the present embodiment, the display control of the image at the projection plate 120 may be performed according to the refractive index of the material of the projection plate 120 and the angle formed by the projection surface 121 of the projection plate 120 and the emission surface 111 of the first display unit 110. Specifically, the display control of the image at the projection plate 120 may be performed according to at least any of the reflectances Iᵣ, Iᵣₚ, and Iᵣₛ of the first image at the projection surface 121 which are calculated based on the refractive index of the material of the projection plate 120 and the angle formed by the projection surface 121 of the projection plate 120 and the emission surface 111 of the first display unit 110. In this manner, in the first embodiment, the display control is realized in consideration of the brightness of the first projection image displayed for the audience, and therefore the image expression is realized having a higher freedom. Note that, while in FIG. 5, only one interface is assumed schematically and the light reflection at the projection surface 121 of the projection plate 120 is examined, when the first image is projected actually onto the projection plate 120, also a component reflected by the transmission surface 122 in the light having entered inside the projection plate 120 can be observed by the audience as the first projection image. In this manner, the brightness of the first projection image actually displayed for the audience takes a value in consideration of the reflections by both of the projection surface 121 and the transmission surface 122. Accordingly, the display control of the image at the projection plate 120 may be performed in consideration of not only the reflectance at the projection surface 121 but also the reflectance at the transmission surface 122. Note that, when the acryl-based resin (refractive index: approximately 1.49) is used as the material of the projection plate 120 and the angle formed by the projection surface 121 of the projection plate 120 and the emission surface 111 of the first display unit 110 is 45 degrees, as a specific configuration example of the image projection apparatus 10 according to the first embodiment, it was confirmed that the reflectance in the oblique incidence is approximately ten and several percent and the first projection image has an effective brightness when actually viewed by human eyes.

Note that, in the present embodiment, an anti-reflection layer such as an AR (Anti Reflection) coat may be provided at the transmission surface 122 of the projection plate 120. By providing the anti-reflection layer at the transmission surface 122, since the reflection of the first image is suppressed at the transmission surface 122, it is possible to prevent the situation that the first projection image can be displayed double for the audience as explained above [1-3. Configuration of a projection plate]. However, when the anti-reflection layer is provided at the transmission surface 122, since the reflection of the first image at the transmission surface 122 is suppressed, it becomes difficult to obtain the contribution of the reflection at the transmission surface 122 to the brightness of the first projection image as described above, and the brightness of the first projection image is reduced. Accordingly, as explained in above [1-3. Configuration of a projection plate], when the phenomenon that the first projection image is displayed double is sufficiently suppressed by means of setting an appropriate value to the thickness of the projection plate 120, it is preferable not to provide the anti-reflection layer at the transmission surface 122 for securing a sufficient brightness of the first projection image. Whether or not to provide the anti-reflection layer at the transmission surface 122 may be determined appropriately according to the situation of applying the image projection apparatus 10 or the situation in which the audience observes the projection image onto the projection plate 120.

### 2. SECOND EMBODIMENT

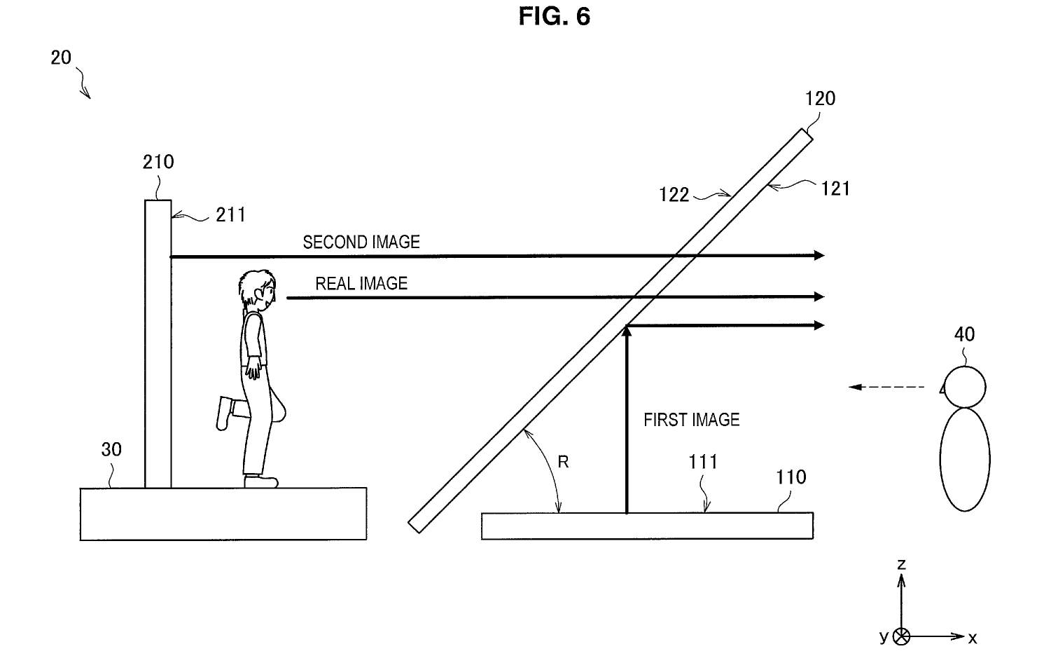

Next, with reference to FIG. 6, there will be explained a configuration example of an image projection apparatus according to a second embodiment of the present disclosure. FIG. 6 is a side view showing a configuration example of the image projection apparatus according to the second embodiment of the present disclosure. Note that, in the following, as in the first embodiment, the case of applying the image projection apparatus according to the second embodiment to various attractions performed on a stage will be explained in FIG. 6 as an example. Accordingly, FIG. 6 illustrates also the stage, an audience observing an attraction performed on the stage and a player performing the attraction on the stage, together with the image projection apparatus according to the second embodiment. FIG. 6 is a diagram corresponding to FIG. 2 which is a side view of the image projection apparatus 10 according to the first embodiment.

With reference to FIG. 6, an image projection apparatus 20 according to the second embodiment of the present disclosure includes the first display unit 110, the projection plate 120, and a second display unit 210. Here, the image projection apparatus 20 according to the second embodiment corresponds to an apparatus in which the second display unit 210 is added to the image projection apparatus 10 according to the first embodiment shown in FIG. 1 and FIG. 2. That is, the functions and the configurations of the first display unit 110 and the projection plate 120 of the image projection apparatus 20 are the same as the functions and the configurations of the first display unit 110 and the projection plate 120 of the image projection apparatus 10 according to the first embodiment explained in above <1. First embodiment>. Accordingly, in the following explanation of the second embodiment, details of the configuration duplicated with that of the first embodiment will be omitted and a function and a configuration of the newly added second display unit 210 will be explained mainly.

The second display unit 210 is display means to display various kinds of information visually to a user in any form such as an image, a character, and a graph, and is configured with a display apparatus or the like, for example. In the following explanation, the second display unit 210 is also called a second display apparatus 210.

The second display unit 210 is disposed on the stage 30 as shown in FIG. 6. Further, the second display unit 210 is disposed so as to project an image (in the following, called a second image) toward the projection plate 120 in a state where an emission surface 211 of the second image is directed to the projection plate 120. In this manner, the second display unit 210 projects the second image to the projection plate 120 from the surface 122 on the opposite side of the projection surface 121 (transmission surface 122) with respect to the projection plate 120. Note that, in the following explanation, the projection image of the second image onto the projection plate 120 is also called a second projection image. Further, the emission surface 211 of the second display unit 210, as with the emission surface 111 of the display unit 110, is a hypothetical surface to emit light forming an image in the second display unit 210, and indicates a plane parallel to the plane defined by the y-axis and the z-axis (y-z plane). When the display screen of the display unit 110 is a flat plane and a plane parallel to the y-z plane, the emission surface 211 may be the same plane as the display screen.

As above, a configuration example of the image projection apparatus 20 according to the second embodiment has been explained with reference to FIG. 6. According to the second embodiment, the following effect can be obtained in addition to the effect obtained in the first embodiment.

As explained with reference to FIG. 6, in the second embodiment, the second display unit 210 is disposed in addition to the configuration of the first embodiment so that the second image is projected onto the projection plate 120 from the surface 122 on the opposite side of the projection surface 121 (transmission surface 122) with respect to the projection plate 120. By the second display unit 210 being disposed in this manner, the second projection image projected from the second display unit 210 is transmitted through the projection plate 120 in the positive direction of the x-axis and observed by the audience 40. Accordingly, the audience 40 positioned in the positive direction of the x-axis can observe an image in which the first projection image projected onto the projection surface 121 of the projection plate 120 from the first display unit 110, the real image transmitted through the transmission surface 122 of the projection plate 120, and the second projection image projected onto the transmission surface 122 of the projection plate 120 from the second display unit 210 are superimposed. In this manner, in the second embodiment, it is possible to further superimpose the second projection image on the image at the projection plate 120 which is provided for the audience 40 in the first embodiment. Accordingly, in the second embodiment, it is possible to provide the audience 40 with a synthesis image formed by more images, and therefore it is possible to perform a wider variety of image expressions. Note that a specific example of the image observed by the audience 40 will be explained in more detail in following [2-2. Application example].

Here, the second display unit 210 may have the same function and the configuration as the first display unit 110. For example, the second display unit 210 may display the second image as a 3D image by the polarization method. As explained in above [1-1. Configuration of an image projection apparatus], the projection plate 120 is configured so as not to change the polarization direction also for the transmission light and so as not to generate the interference between the reflection light at the transmission surface 122 and the reflection light at the projection surface 121. Accordingly, when the second display unit 210 displays the second image as a 3D image by the polarization method, since the second projection image is transmitted through the projection plate 120 while keeping the polarization direction thereof, the audience 40 can observe the second projection image as a 3D image.

Further, for example, the second display unit 210 may be configured with an LED display apparatus. When configured with the LED display apparatus, the second display unit 210, as with the first display unit 110, can project an image brighter than the projection image by the projector, and therefore it becomes possible to provide an image having a brightness consistent with the brightness of the lighting to illuminate the stage 30 or the brightness of the first projection image.

Here, the configuration of the projection plate 120 of the image projection apparatus 20 may be determined as explained in above [1-3. Configuration of a projection plate]. Further, the display control of the image at the projection plate 120 of the image projection apparatus 20 may be performed as explained in above [1-4. Display control of an image at a projection plate]. However, in the second embodiment, the second image is further projected onto the projection plate 120 in addition to the situation shown in the first embodiment. Accordingly, the configuration of the projection plate 120 of the image projection apparatus 20 may be determined further in consideration of the brightness of the second projection image on the projection plate 120, how the second projection image is viewed by the audience 40 on the projection plate 120, (image display shift amount or the like caused by the reflection and the refraction when the light included in the second image is transmitted through the projection plate 120), and the like in addition to the contents explained in above [1-3. Configuration of a projection plate]. Further, the display control of the image on the projection plate 120 of the image projection apparatus 20 may be determined further in consideration of the reflectance and the transmittance of the second projection image on the projection plate 120 (i.e., brightness of the second projection image on the projection plate 120), how the second projection image is viewed by the audience 40 on the projection plate 120, and the like in addition to the contents explained in above [1-4. Display control of an image at a projection plate].

Note that the present technique is not limited to the configuration explained in the first and second embodiments, and a larger number of display units may be provided. For example, a display unit (display apparatus) may be further added to the configuration of the image projection apparatus 20 according to the second embodiment, and another image may be projected onto the projection plate 120 from another direction. In this case, the configuration of the projection plate 120 and the display control of the image at the projection plate 120 may be determined further in consideration of the brightness of the additional projection image from the added display unit on the projection plate 120, how the additional image is viewed by the audience 40 on the projection plate 120, and the like. In this manner, the configuration of the projection plate 120 and the display control of the image at the projection plate 120 in the present technique can be set appropriately according to the display state on the projection plate 120 (e.g., display brightness, a shift amount, and the like of the image) for the various kinds of image projected onto the projection plate 120 such as the real image on the stage 30, the first projection image, the second projection image, and/or the additional projection image, based on the contents explained in above [1-3. Configuration of a projection plate] and [1-4. Display control of an image at a projection plate].

[2-2. Application example]

Next, there will be explained an application example of the image projection apparatus 20 according to the second embodiment with reference to FIG. 7A to FIG. 7B. FIG. 7A to FIG. 7B are explanatory diagrams for explaining an application example of the image projection apparatus 20 according to the second embodiment. FIG. 3A to FIG. 3C schematically show an image on the projection plate 120 observed by the audience 40 when the image projection apparatus 10 according to the first embodiment is applied to an attraction (e.g., drama) performed on the stage 30. That is, FIG. 7A to FIG. 7B express the views of the audience 40 in the state that the audience 40 in FIG. 6 observes the stage 30 through the projection plate 120 from a position in the positive direction of the x-axis.

Here, as described above, in the second embodiment, the audience 40 positioned in the positive direction of the x-axis is provided with an image in which the first projection image projected onto the projection surface 121 of the projection plate 120 from the first display unit 110, the real image transmitted through the transmission surface 122 of the projection plate 120, the second projection image projected onto the transmission surface 122 of the projection plate 120 from the second display unit 210 are superimposed. Among these images, the real image transmitted through the transmission surface 122 of the projection plate 120 is observed by the audience 40 as illustrated in FIG. 3A, for example. Further, the first projection image projected onto the projection surface 121 of the projection plate 120 from the first display unit 110 is observed by the audience 40 as illustrated in FIG. 3B, for example. Accordingly, here, also in the second embodiment, the same images as the images shown in FIG. 3A and FIG. 3B are assumed to be displayed as the real image and the first projection image, and detailed explanation will be omitted for the real image and the first projection image.

FIG. 7A shows the second projection image which is projected onto the transmission surface 122 of the projection plate 120 from the second display unit 210 and observed by the audience 40. With reference to FIG. 7A, a second projection image 513 is displayed in the display region 510. FIG. 7A corresponds to an image observed by the audience 40 when the first display unit 110 does not display the first image and the second display unit 210 displays the second image. In this case, the second projection image projected from the second display unit 210 is displayed on the projection plate 120. In the example shown in FIG. 7A, the second projection image 513 is a landscape image capturing a famous oversea sight-seeing site and is displayed across the whole area of the display region 510. In this manner, a background image of a drama may be displayed as the second projection image 513, for example. Note that FIG. 7A illustrates only the second projection image 513 and omits the illustration of an object on the stage 30 which is actually to be observed by the audience 40 for convenience of explanation.

FIG. 7B shows an image which is observed by the audience 40 and in which the first projection image projected onto the projection surface 121 of the projection plate 120 from the first display unit 110, the real image transmitted through the transmission surface 122 of the projection plate 120, and the second projection image projected onto the transmission surface 122 of the projection plate 120 from the second display unit 210 are superimposed. With reference to FIG. 7B, the real image 511, the first projection image 512, and the second projection image 513 are displayed together in the display region 510. FIG. 7B shows an image observed by the audience 40 when the first display unit 110 displays the first image and the second display unit 210 displays the second image. In this manner, the audience 40 can observe the real image 511 on the stage 30 through the projection plate 120, and, at the same time, can observe the first projection image 512 projected onto the projection plate 120 from the first display unit 110 and the second projection image 513 projected onto the projection plate 120 from the second display unit 210.

As above, an application example of the image projection apparatus 20 according to the second embodiment has been explained with reference to FIG. 7A and FIG. 7B. As explained above, in the second embodiment, the audience 40 can observe the real image 511 (e.g., object on the stage 30) which exists on the other side of the projection plate 120, through the projection plate 120, and can also observe the first projection image 512 which is a 3D image projected onto the projection plate 120 from the first display unit 110 and the second projection image 513 projected onto the projection plate 120 from the second display unit 210. In this manner, the audience is provided with an image in which the real image 511 (e.g., player on the stage), the first projection image 512 (e.g., animation character), and the second projection image 513 (e.g., background image) are combined, and thereby it becomes possible to perform a wider variety of image expressions than in the first embodiment. Further, in the second embodiment, also the second projection image 513 may be displayed as a 3D image together with the first projection image 512. By displaying the first projection image 512 and the second projection image 513 as 3D images, it becomes possible to provide the audience 40 with an image having more presence.

### 3. CONCLUSION

As explained above, in the first embodiment of the present disclosure, the following effect can be obtained. According to the present disclosure, the first display unit 110 that displays the first image as a three-dimensional image by the polarization method and the projection plate 120 which is formed by an optically isotropic material in a predetermined thickness and onto which the first image is projected by the first display unit 110 are provided. Further, the projection plate 120 is disposed such that a projection surface 121 onto which the first image is projected is inclined at a predetermined angle with respect to an emission surface of the first image in the first display unit 110, and also transmits at least a part of light from a surface 122 on an opposite side of the projection surface 121. Accordingly, the first image of the three-dimensional image projected onto the projection plate 120 is reflected at a predetermined angle while keeping the polarization direction of the light forming the first image, and provided for an audience observing the projection plate 120 in the reflection direction thereof as the first projection image of the three-dimensional image. Further, a real image disposed in the direction of the surface 122 on the opposite side of the projection surface 121 of the first image is provided for the audience observing the projection plate 120 as the transmission image transmitted through the projection plat 120. Accordingly, an image in which the first projection image of the three-dimensional image and the real image existing on the other side of the projection plate 120 are superimposed is provided for the audience observing the projection plate 120. Accordingly, it becomes possible to provide the audience with an image having more presence and to perform a wider variety of image expressions.

Further, in the second embodiment, the following effect can be further obtained in addition to the effect obtained by the first embodiment. In the second embodiment, the second display unit 210 is disposed in addition to the configuration of the first embodiment so that the second image is projected onto the projection plate 120 from the surface 122 on the opposite side of the projection surface 121 (transmission surface 122) with respect to the projection plate 120. By the disposition of the second display unit 210 in this manner, the second projection image projected from the second display unit 210 is transmitted through the projection plate 120 in the same direction as the real image and provided for the audience observing the projection plate 120 as a transmission image transmitted through the projection plate 120. Accordingly, the audience 40 observing the projection plate 120 can observe an image in which the first projection image projected onto the projection surface 121 of the projection plate 120 from the first display unit 110, the real image transmitted through the transmission surface 122 of the projection plate 120, and the second projection image projected onto the transmission surface 122 of the projection plate 120 from the second display unit 210 are superimposed. In this manner, in the second embodiment, it is possible to further superimpose the second projection image on the image at the projection plate 120 which is provided for the audience 40 in the first embodiment. Accordingly, in the second embodiment, it is possible to provide the audience 40 with a synthesis image formed by more images, and therefore it is possible to perform a wider variety of image expressions.

Note that, while, in the above explanation, the configurations of the image projection apparatuses 10 and 20 according to the first and second embodiments for realizing the present technique have been explained, the present technique is not limited to such examples. As explained in above [1-1. Configuration of an image projection apparatus] and [2-1. Configuration of an image projection apparatus], the first display unit 110 and the second display unit 210 are configured with display apparatuses capable of displaying the first image and the second image, and can be assumed as a first display apparatus 110 and a second display apparatus 210, respectively. Accordingly, in the first embodiment, the image projection apparatus 10 can be assumed as an image projection system 10 including the first display apparatus 110 and the projection plate 120. Further, in the second embodiment, the image projection apparatus 20 can be assumed as an image projection system 20 including the first display apparatus 110, the projection plate 120, and the second display apparatus 210.

Further, in the configuration explained in above <1. First embodiment>, by the projection of the first image onto the projection plate 120 from the first display unit 110, an image in which the real image transmitted through the projection plate 120 (real image at the projection plate 120 of an object existing in the direction of the surface on the opposite side of the surface onto which the first image is projected from the first display unit 110) and the first projection image are superimposed is displayed on the projection plate 120. Accordingly, the contents explained in above <1. First embodiment> can be also said to be the explanation of an image projection method according to the first embodiment of the present disclosure. Note that the image projection method according to the first embodiment of the present disclosure may include dynamic display control of the image at the projection plate 120 according to the contents and the progress of an attraction to which the image projection method is applied as explained in above [1-4. Display control of an image at a projection plate].

In a similar way, further, in the configuration explained in above <2. Second embodiment>, by the projection of the first image onto the projection plate 120 from the first display unit 110 and the projection of the second image onto the projection plate 120 from the second display unit 110, an image in which the real image transmitted through the projection plate 120 (real image at the projection plate 120 of an object existing in the direction of the surface on the opposite side of the surface onto which the first image is projected from the first display unit 110) and the first and second projection images are superimposed is displayed on the projection plate 120. Accordingly, the contents explained in above <2. Second embodiment> can be also said to be the explanation of an image projection method according to the second embodiment of the present disclosure. Note that the image projection method according to the second embodiment of the present disclosure may include dynamic display control of the image at the projection plate 120 according to the contents and the progress of an attraction to which the image projection method is applied as explained in above [1-4. Display control of an image at a projection plate].

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

For example, while the above embodiments explain the case where the first projection image and the second projection image are a character or a landscape image, the present technique is not limited to such an example. Each of the first projection image and the second projection image may be a character (text), light having a predetermined color, or the like, for example. Specifically, a predetermined message may be displayed in a text format as the first projection image or the second projection image, or light having a predetermined color may be displayed in a predetermined region of the projection plate 120 for various kinds of staging.

Additionally, the present technology may also be configured as below.

(1) An image projection apparatus including:

a first display unit to display a first image as a three-dimensional image utilizing a difference in a polarization direction of emission light; and

a projection plate which is formed by an optically isotropic material in a predetermined thickness and onto which the first image is projected by the first display unit,

wherein the projection plate is disposed in a manner that a projection surface of the first image is inclined at a predetermined angle with respect to an emission surface of the first image in the first display unit, and also transmits at least a part of light from a surface on an opposite side of the projection surface.

(2) The image projection apparatus according to (1), further including

a second display unit to display a second image projected onto the projection plate from a direction different from a projection direction of the first image from the first display unit.

(3) The image projection apparatus according to (2),

wherein the second display unit projects the second image to the projection plate from a surface on an opposite side of the projection surface of the first image.

(4) The image projection apparatus according to any one of (1) to (3),

wherein a thickness of the projection plate is determined based on at least a refractive index of material of the projection plate and a pixel interval in the emission surface of the first display unit.

(5) The image projection apparatus according to any one of (1) to (4),

wherein a display state of an image at the projection plate is controlled according to a refractive index of a material of the projection plate and an angle formed by the projection surface of the projection plate and the emission surface of the first display unit.

(6) The image projection apparatus according to (5),

wherein a display state of an image at the projection plate is controlled according to a reflectance of p-polarized light and a reflectance of s-polarized light at the projection plate.

(7) The image projection apparatus according to any one of (1) to (6),

wherein the material of the projection plate is an acryl-based resin.

(8) The image projection apparatus according to any one of (1) to (7),

wherein a disposition angle of the projection surface of the projection plate with respect to the emission surface of the first display unit is 45 degrees.

(9) The image projection apparatus according to any one of (1) to (8),

wherein a thickness of the projection plate is approximately 1 mm to 5 mm.

(10) The image projection apparatus according to any one of (1) to (9),

wherein, when the material of the projection plate is an acryl-based resin and a pixel interval in a display screen of the first display unit is approximately 4 mm, a thickness of the projection plate is approximately 2 mm.

(11) An image projection system including:

a first display apparatus to display a first image as a three-dimensional image utilizing a difference in a polarization direction of emission light; and

a projection plate which is formed by an optically isotropic material in a predetermined thickness and onto which the first image is projected by the first display apparatus,

wherein the projection plate is disposed in a manner that a projection surface of the first image is inclined at a predetermined angle with respect to an emission surface of the first image in the first display apparatus, and also transmits at least a part of light from a surface on an opposite side of the projection surface.

(12) An image projection method including:

projecting a first image of a three-dimensional image onto a projection plate formed by an optically isotropic material in a predetermined thickness from a first display apparatus to display the first image utilizing a difference in a polarization direction of emission light,

wherein the projection plate is disposed in a manner that a projection surface of the first image is inclined at a predetermined angle with respect to an emission surface of the first image in the first display apparatus, and also transmits at least a part of light from a surface on an opposite side of the projection surface.

(13) A display apparatus which

displays a first image of a three-dimensional image by emitting light having a different polarization direction from an emission surface, and

projects the first image toward a projection surface of a projection plate that has the projection surface disposed to be inclined at a predetermined angle with respect to the emission surface, that is formed by an optically isotropic material in a predetermined thickness, and that transmits at least a part of light from a surface on an opposite side of the projection surface.

### REFERENCE SIGNS LIST

10, 20 image projection apparatus (image projection system)
30 stage
40 audience
110 first display unit
111 emission surface
120 projection plate
121 projection surface
122 transmission surface
210 second display unit
211 emission surface
310, 511 real image
510 display region
512 first projection image
513 second projection image

1. An image projection apparatus comprising:
a first display unit to display a first image as a three-dimensional image utilizing a difference in a polarization direction of emission light; and
a projection plate which is formed by an optically isotropic material in a predetermined thickness and onto which the first image is projected by the first display unit,
wherein the projection plate is disposed in a manner that a projection surface of the first image is inclined at a predetermined angle with respect to an emission surface of the first image in the first display unit, and also transmits at least a part of light from a surface on an opposite side of the projection surface.

2. The image projection apparatus according to claim 1, further comprising
a second display unit to display a second image projected onto the projection plate from a direction different from a projection direction of the first image from the first display unit.

3. The image projection apparatus according to claim 2,
wherein the second display unit projects the second image to the projection plate from a surface on an opposite side of the projection surface of the first image.

4. The image projection apparatus according to claim 1,
wherein a thickness of the projection plate is determined based on at least a refractive index of material of the projection plate and a pixel interval in the emission surface of the first display unit.

5. The image projection apparatus according to claim 1,
wherein a display state of an image at the projection plate is controlled according to a refractive index of a material of the projection plate and an angle formed by the projection surface of the projection plate and the emission surface of the first display unit.

6. The image projection apparatus according to claim 5,
wherein a display state of an image at the projection plate is controlled according to a reflectance of p-polarized light and a reflectance of s-polarized light at the projection plate.

7. The image projection apparatus according to claim 1,
wherein the material of the projection plate is an acryl-based resin.

8. The image projection apparatus according to claim 1,
wherein a disposition angle of the projection surface of the projection plate with respect to the emission surface of the first display unit is 45 degrees.

9. The image projection apparatus according to claim 1,
wherein a thickness of the projection plate is approximately 1 mm to 5 mm.

10. The image projection apparatus according to claim 1,
wherein, when the material of the projection plate is an acryl-based resin and a pixel interval in a display screen of the first display unit is approximately 4 mm, a thickness of the projection plate is approximately 2 mm.

11. An image projection system comprising:
a first display apparatus to display a first image as a three-dimensional image utilizing a difference in a polarization direction of emission light; and
a projection plate which is formed by an optically isotropic material in a predetermined thickness and onto which the first image is projected by the first display apparatus,
wherein the projection plate is disposed in a manner that a projection surface of the first image is inclined at a predetermined angle with respect to an emission surface of the first image in the first display apparatus, and also transmits at least a part of light from a surface on an opposite side of the projection surface.

12. An image projection method comprising:
projecting a first image of a three-dimensional image onto a projection plate formed by an optically isotropic material in a predetermined thickness from a first display apparatus to display the first image utilizing a difference in a polarization direction of emission light,
wherein the projection plate is disposed in a manner that a projection surface of the first image is inclined at a predetermined angle with respect to an emission surface of the first image in the first display apparatus, and also transmits at least a part of light from a surface on an opposite side of the projection surface.

13. A display apparatus comprising:
displays a first image of a three-dimensional image by emitting light having
a different polarization direction from an emission surface, and projects the first image toward a projection surface of a projection plate that has the projection surface disposed to be inclined at a predetermined angle with respect to the emission surface, that is formed by an optically isotropic material in a predetermined thickness, and that transmits at least a part of light from a surface on an opposite side of the projection surface.
